(19) United States
(12) Patent Application Publication
(10) Pub. No.: US 2009/0024695 A1
(43) Pub. Date: Jan. 22, 2009

(54) Methods, Systems, And Computer Program Products For Providing Search Results Based On Selections In Previously Performed Searches

(76) Inventors: Robert P. Morris, Raleigh, NC (US); Mona Singh, Cary, NC (US)

Correspondence Address: SCENERA RESEARCH, LLC, 111 CORNING RD., SUITE 220, CARY, NC, 27518, US

(21) Appl. No.: 11/779,617

(22) Filed: Jul. 18, 2007

(51) Int. Cl. G06F 7/06; G06F 15/16; G06F 17/30

(52) U.S. Cl. 709/203; 707/2; 707/E17.017

(57) ABSTRACT

Methods and systems are described for providing search results based on selections in previously performed searches. A search is performed based on a first search term. A result set from the performed search is provided. A selection of a member of the result set from the performed search is received. It is determined whether the selected member is associated with a second search term using an index that associates members from previously performed searches with corresponding search terms. A second result set is provided based on the second search term when the selected member is determined to be associated with the second search term.

### BACKGROUND

Tagging is becoming widespread in various arenas. In general, tags are user-generated labels associated with content that is available on the Internet. The labels are typically words or phrases that aid users in sharing content by providing meaning and/or context information to content. Tagging offers many advantages, such as enhancing searches for content.

Users need ways to add tags that are descriptive of the content. Currently, users readily provide search terms in order to find a needed resource. A search term may be viewed as a tag when associated with a resource selected by a user from amongst a search results set. Since search “tags” are user-provided, a folksonomy of tags can effectively be created that are associated with searchable network resources. This “tagging” of search results can provide for improved search results.

Accordingly, there exists a need for methods, systems, and computer program products for providing search results based on selections in previously performed searches.

### SUMMARY

Methods and systems are described for providing search results based on selections in previously performed searches. In one aspect, a search is performed based on a first search term. A result set from the performed search is provided. A selection of a member of the result set from the performed search is received. It is determined whether the selected member is associated with a second search term using an index that associates members from previously performed searches with corresponding search terms. A second result set is provided based on the second search term when the selected member is determined to be associated with the second search term.

In another aspect, a system for providing search results based on selections in previously performed searches includes: means for performing a search based on a first search term; means for providing a result set from the performed search; means for receiving a selection of a member of the result set from the performed search; means for determining whether the selected member is associated with a second search term using an index that associates members from previously performed searches with corresponding search terms; and means for providing a second result set based on the second search term when the selected member is determined to be associated with the second search term.

In another aspect, a system for providing search results based on selections in previously performed searches includes: a search engine component configured for performing a search based on a first search term and for providing a result set from the performed search; a selection receiver component configured for receiving a selection of a member of the result set from the performed search; a tag index engine component configured for determining whether the selected member is associated with a second search term using an index that associates members from previously performed searches with corresponding search terms; and a search refiner component configured for providing a second result set based on the second search term when the selected member is determined to be associated with the second search term.

In another aspect, a computer readable medium includes a computer program, executable by a machine, for providing search results based on selections in previously performed searches. The computer program includes executable instructions for: performing a search based on a first search term; providing a result set from the performed search; receiving a selection of a member of the result set from the performed search; determining whether the selected member is associated with a second search term using an index that associates members from previously performed searches with corresponding search terms; and providing a second result set based on the second search term when the selected member is determined to be associated with the second search term.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for providing search results based on selections in previously performed searches according to an aspect of the subject matter described herein;

FIG. 2 is a block diagram illustrating a system for providing search results based on selections in previously performed searches according to another aspect of the subject matter described herein;

FIGS. 3 and 4 are block diagrams illustrating exemplary structures for tag indices according to other aspects of the subject matter described herein; and

FIG. 5 is a message flow diagram illustrating a message flow for providing search results based on selections in previously performed searches according to another aspect of the subject matter described herein.

### DETAILED DESCRIPTION

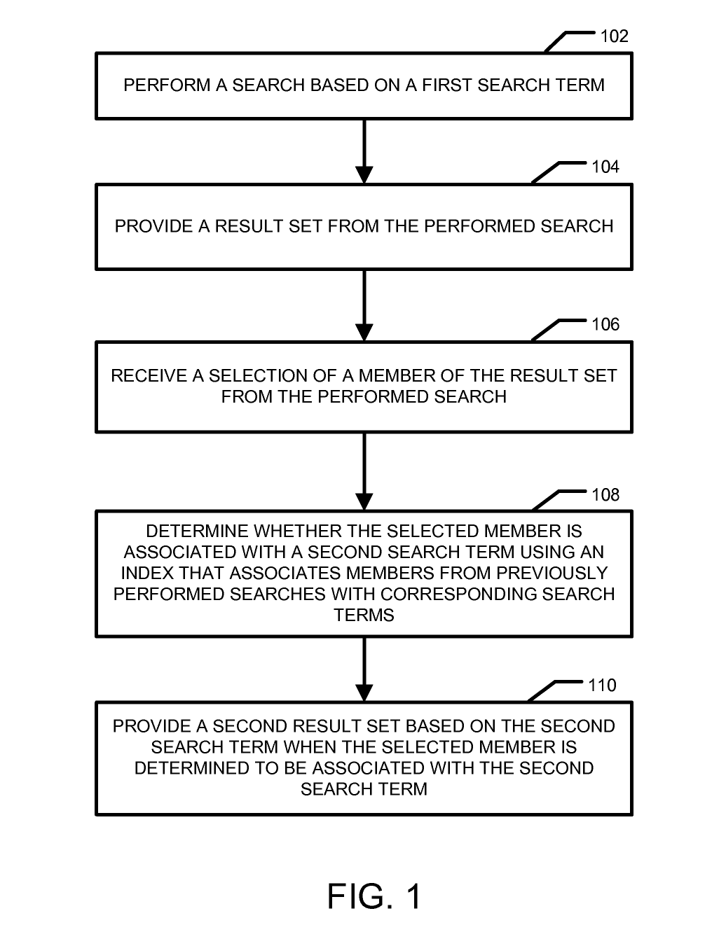

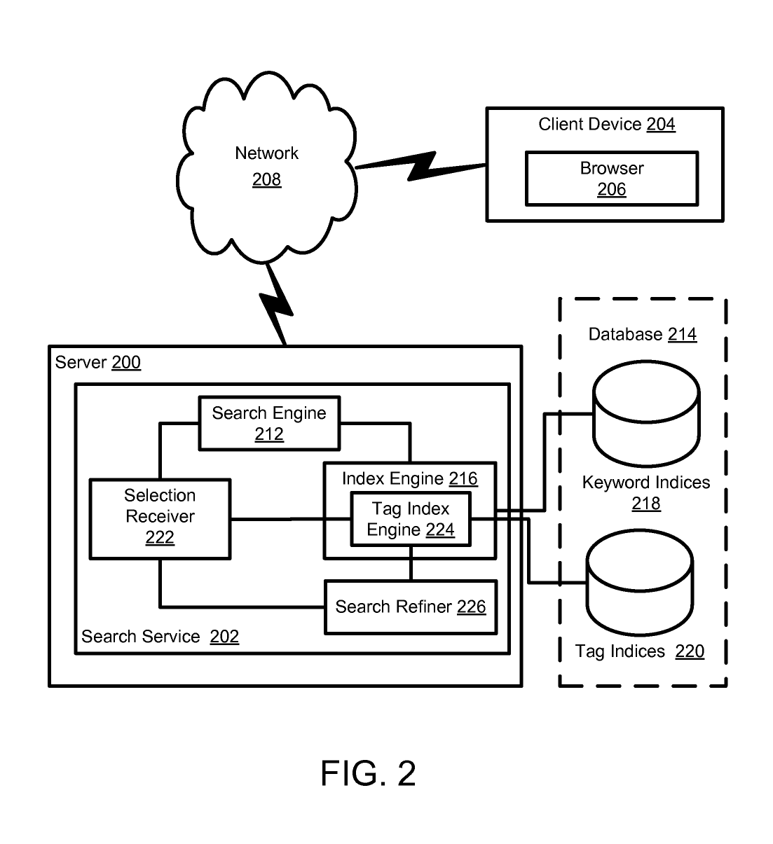

FIG. 1 is a flow diagram illustrating a method for providing search results based on selections in previously performed searches according to an exemplary aspect of the subject matter described herein. FIG. 2 is a block diagram illustrating a system for providing search results based on selections in previously performed searches according to another exemplary aspect of the subject matter described herein. The method illustrated in FIG. 1 can be carried out by, for example, some or all of the components illustrated in the exemplary system of FIG. 2. In the exemplary system of FIG. 2, a server 200 is shown that includes a search service 202 configured for providing search results based on selections in previously performed searches.

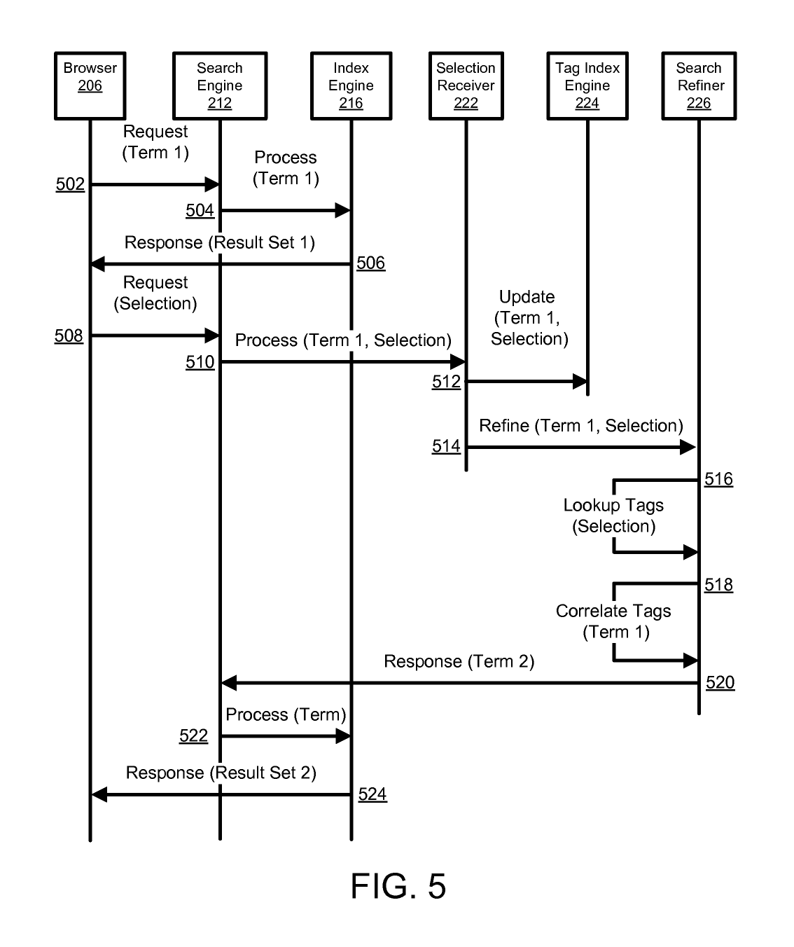

FIG. 5 is a message flow diagram illustrating a message flow for providing search results based on selections in previously performed searches according to another exemplary aspect of the subject matter described herein. Reference is made to the exemplary messages depicted in FIG. 5 throughout this document.

With reference to FIG. 1, in block 102 a search is performed based on a first search term. Accordingly, a system for providing search results based on selections in previously performed searches includes means for performing a search based on a first search term. For example, as illustrated in FIG. 2, a search engine component 212 of the search service 202 can be configured for performing a search based on a first search term.

The search service 202 can be, for example, a web application configured to provide a search form to a client device 204 for display in a browser 206. Communications between the browser 206 and search service 202 are carried out via a network 208, such as a local area network (LAN), wide area network (WAN), personal area network (PAN), a wireless network, a cellular network, the Internet, and the like, or any combination of the preceding. The search service 202 operates using an operating environment provided by the server 200. The operating environment can include, for example, a processor, processor memory, a persistent data store, a network interface (NIC) such as an Ethernet NIC, and various subsystems for supporting hardware components for input and output such as the NIC, a hard drive controller and a hard driver, a display controller and a display, to name a few examples.

In operation, a search term is received via the provided form by the browser 206 through a user interface of the client device 204 or automatically via an application of the client device 204. The browser 206 sends the received search term via the network 208 to the search service 202 where the term is received by a search engine component 212 for processing. For example, the browser 206 can send a hypertext transport protocol (HTTP) request message that includes a search term to the search engine component 212, as depicted by message 502 of FIG. 5. Although HTTP will be used by way of example to describe the exemplary message flow of FIG. 5, it should be understood that other communication protocols could be used, such as a publish/ subscribe protocol (including presence protocol), file transfer protocol, and the like, via wired and/or wireless physical media. For example, the message 502 can include a search term included in a subscription message sent via a publish/subscribe protocol from the browser 206 to establish a subscription on behalf of a principal. The search term may be provided to the search engine component 212 as entered at the browser 206 or may be transformed into a search query by the browser, the search engine component 212, another interim component (not shown), or any combination thereof.

In one aspect, a selection of a member of the result set from the performed search is received based on a selection of the member at the browser 206 without activating a link for retrieving a resource associated with the member.

As used herein, the term “search term” includes any search query or queries that are generated based on the search term received by the browser 206. That is, a search term includes any information provided to the search engine component 212 by the browser 206 in connection with a search term received by the browser 206. For example, typically, the search engine component 212 transforms the search term or resulting search query into one or more commands compatible with a search language supported by a database 214 associated with the search service 202. In one example, the database 214 can be a structured query language (SQL) database and the search language would, therefore, be a version of SQL. Of course other search languages and databases can alternatively or additionally be employed.

The search engine component 212 invokes an index engine component 216 to process the commands in the search language of the database 214, as depicted by message 504 of FIG. 5. The index engine component 216 is also configured to create and maintain various search indices used by the search service 202. For example, the database 214 can include a set of keyword indices built using a web bot, such as a web crawler, a spider, and the like, to probe accessible devices on the Internet for content. The content, for example, is analyzed based on its type and format, if known, to detect keywords and relationships between detected keywords using knowledge of the content type format. A keyword index 218 can then be created that links keywords to resources discovered by the web bot. For example, a keyword index 218 can be embodied as a database table with a row for storing keywords and a row for storing uniform resource locators (URLs) pointing to associated resources. In another example, records in the index can be weighted based on a discoverable characteristic, such as the number of times a keyword occurs in a particular resource and/or the number of links discovered that reference a resource including a particular keyword. In a further example, an index can be created and maintained that associates multiple keywords that are discovered in the same web resource or resources. In such a case, the keyword index 218 table can include a column for a first keyword, a column for a second keyword, and a column indicating the distance between the two keywords in a particular resource. Relationships between a keyword and a resource in a keyword index 218 can also be weighted based on where the keyword occurs in the resource. For example, a keyword discovered in a title of a document can be more highly correlated with a resource than the same keyword discovered in a paragraph near the end of the resource.

Returning to FIG. 1, in block 104 a result set from the performed search is provided. Accordingly, a system for providing search results based on selections in previously performed searches includes means for providing a result set from the performed search. For example, as illustrated in FIG. 2, the search engine component 212 is configured for providing a result set from the performed search.

Prior to providing the result set from the performed search, the search engine component 212 can format some or all of the result for presentation by the browser 206. The search engine component 212 provides the result set to the browser 206 in a message from the search service 202 via the network 208. For example, the result set can be sent in an HTTP response message, as depicted by message 506 of FIG. 5. Alternately, the message 506 can include the result set sent via a notify message of a publish/subscribe protocol. As new resources are detected by the search service 202, an additional notify message including an updated search result and/or new results corresponding to the search term can be provided to the browser 206, pursuant to a subscription and/or simply as a directed notify message. The browser 206 presents some or all of the result set on a display (not shown), for example.

Alternatively, the search engine component 212 can provide the result set to a proxy service, a web service included in an automated process, and/or any networked receiver capable of receiving and processing the result set.

Returning to FIG. 1, in block 106 a selection is received of a member of the result set from the performed search. Accordingly, a system for providing search results based on selections in previously performed searches includes means for receiving a selection of a member of the result set from the performed search. For example, as illustrated in FIG. 2, a selection receiver component 222 is configured for receiving a selection of a member of the result set from the performed search.

In one aspect, receiving a selection of a member of the result set from the performed search includes processing a message received from the browser 206 to determine the selected member, where the message identifies the selected member. For example, the selection receiver component 222 can be configured for receiving a selection of a member of the result set from the performed search by processing a received message that identifies the selected member to determine the selected member. As depicted by messages 508 and 510 of FIG. 5, the selection of a member of the result set from the performed search can be received from the browser 206 in, for example, an HTTP request message by the search engine component 212 and forwarded to the selection receiver component 222. Alternately, the selection of a member of the result set from the performed search can be received via a subscribe message 508 for updating an existing subscription associated with the result set or for creating a new subscription. In the case of updating an existing subscription, each selected member, in effect, modifies the original search. In the case of creating a new subscription, the selection creates a subscription related to the first search as will be described. In yet another alternative, the selection of a member can be received via a publish message 508 where the published selection information results in a notify message associated with the original subscription, as is described below.

At the browser 206, the selection of a member of the result set can be received based on input received by a user interface of the client device 204, such as a mouse click on a presented link to a resource. Alternatively, the browser and/or a browser plug-in can automatically select a member of the result set based on predetermined selection criteria. Just as users select result members for their own specific purposes, an executable program that is provided with the result set can select members based on preconfigured selection criteria as configured by the developers of the executable program.

A message is generated by the browser 206 that identifies the selected member and may include the search term or an identifier of the search term. The message is transmitted by the browser 206 using the network 208 to the server 200 for receipt and processing by the selection receiver component 222.

In another aspect, receiving a selection of a member of the result set from the performed search includes selecting the member according to a policy that is associated with at least one of a submitter of the first search term, the client, an administrator associated with the submitter, and by a search service. For example, the selection receiver component 222 can be configured for receiving a selection of a member of the result set from the performed search by selecting the member according to a policy that is associated with at least one of a submitter of the first search term (e.g., a user of the browser 206), the client (e.g., the browser 206), an administrator associated with the submitter, and by the search service 202. The selection receiver component 222 uses the policy to select one or more members of the result set. For example, the policy can provide for selection of a member of the result set based on a profile associated with the submitter and/or a ranking among members of the result set. A policy, for example, can provide that a member of the result set that is among the top ranked (e.g., as specified absolutely by number or relatively by a percentage) is to be selected, that a member that best matches a profile associated with the submitter is to be selected, that a member that is selected the most by users within a determinable time period, such as the last hour, is to be selected, and/or that a member selected by submitters matching the current submitter's profile is to be selected. One skilled in the art should appreciate that any number of policies can be provided and the examples provided herein are not exhaustive.

Returning to FIG. 1, in block 108 it is determined whether the selected member is associated with a second search term using an index that associates members from previously performed searches with corresponding search terms. Accordingly, a system for providing search results based on selections in previously performed searches includes means for determining whether the selected member is associated with a second search term using an index that associates members from previously performed searches with corresponding search terms. For example, as illustrated in FIG. 2, a tag index engine component 216 is configured for determining whether the selected member is associated with a second search term using an index that associates members from previously performed searches with corresponding search terms.

The database 214 associated with the search service 202 depicted in FIG. 2 also includes one or more tag indices 220. A tag index 220 associates selected members from previously performed searches with corresponding search terms. For constructing a tag index, the selection receiver component 222 receives the member selection from the result set from, for example, the browser 206 and can also receive the search term either with the selection from the browser 206 or from the search engine component 212. In the later case, the search term is available from the search engine component 212 in session data received from, for example, the browser 206 for performing the search. To build or update the tag index 220, the member selection information and the search term are provided to the tag index engine component 224 by the selection receiver 222, as depicted by “Update” message 512 in FIG. 5. The tag index engine component 224 creates or updates a record associating the member selection (or the resource corresponding to the member selection) with one or more of the terms in the search term used to generate the earlier result set. In an aspect, a lookup for an association including the first search term and the selected member of the second result set is performed and a correlation included in the association is adjusted if the association is found or an association including the first search term, the selected member, and a correlation is created if the association is not found.

Tag indices can also be weighted in a variety of ways. For example, the tag index 220 can weight the associations between the selected members and the terms according to the number of times a tag occurs in a resource associated with the selected member, the number of links that reference a resource associated with the selected member, where portions of an associated reference corresponding to a tag are in the resource associated with the selected member.

The tag index 220, as used herein, can take the form of a content-tag index 220 that can be used to locate a tag or keyword given a resource or content identifier (i.e., a selected member), a tag-content index 220 that can be used to locate a resource or content identifier (i.e., a selected member) given a tag or keyword, or a combination of the two. Whether an index is a tag-content index 220 or a content-tag index 220 is primarily based on how the index is used.

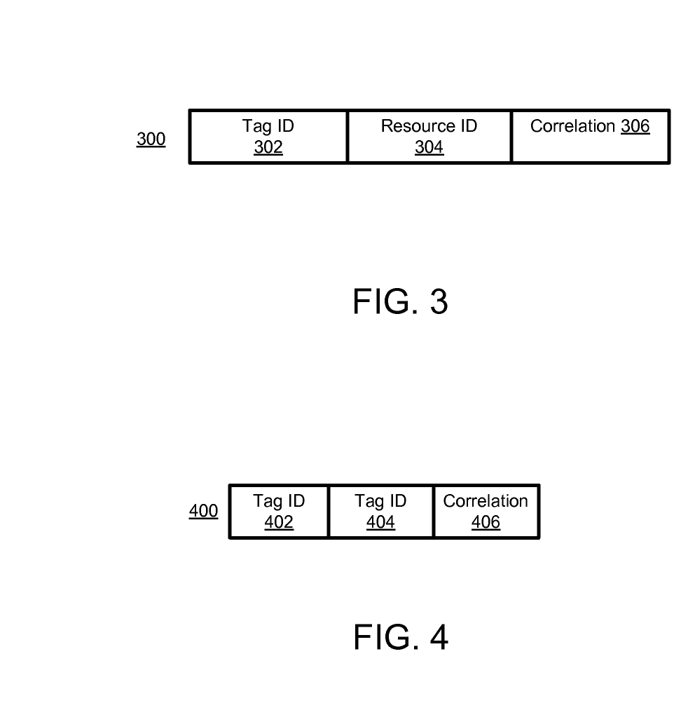

FIG. 3 is a block diagram illustrating an exemplary tag index structure 300, the tag index 220 includes a tag ID 302 that identifies a tag, a resource ID 304 that identifies a resource corresponding to a selected member of the result set and/or the selected member itself, and weighting information 306, as described above and below.

An exemplary tag index represented as a table is shown in Table 1. In the example depicted by Table 1, the count corresponds to the number of times the tag is located in the resource.

TABLE 1

| Tag ID | Resource ID | Count |
|---|---|---|
| President | URI of Picture of Lincoln Memorial | 22 |
| President | URI of Picture of Mount Rushmore | 27 |
| Rushmore | URI of Picture of Mount Rushmore | 18 |
| Rushmore | URI of Movie: North by Northwest | 7 |

The tag index 220 can also associate tags with other tags. FIG. 4 is a block diagram illustrating a tag-tag index structure 400 that includes a first tag ID 402, a second tag ID 404, and weighting information 406.

The tag index engine component 224 can use the tag index 220 to filter search results that are performed based on the keyword index 218 and/or can use the tag index 220 to rank the result set of a search performed based on the keyword index 218.

In operation, the selected member (or members) received by the selection receiver component 222 is provided to a search refiner component 226, as depicted by “Refine” message 514 in FIG. 5, for determining whether the selected member is associated with a second search term using the tag index 220. For example, the search refiner component 226 can be configured for performing a search of the tag index 220 based on the selected member to locate a tag in the tag index 220, as depicted by message 516 of FIG. 5. The one or more located tags can then be used to generate a second search query for searching again the keyword index 218, as will be discussed further below.

Accordingly, in one aspect, determining whether the selected member is associated with a second search term using an index includes locating, based on the selected member, a tag corresponding to the second search term in a tag index that associates a tag with a resource. For example, the index engine component 216 can be configured for determining whether the selected member is associated with a second search term using an index by locating, based on the selected member, a tag corresponding to the second search term in the tag index 224.

In another aspect, determining whether the selected member is associated with a second search term using an index includes locating, based on the selected member, a tag corresponding to the second search term in the tag index 220 according to a policy that is associated with a submitter of the first search term, the client, an administrator associated with the submitter, and/or by a search service. For example, a policy can be provided as a set of custom weights associated with entries in the tag index. Thus, if the weights are based on behavior of the submitter or a group of individuals with similar interests, the policy is customized for the submitter and/or the group. An administrator can configure weightings to be used for a particular individual or group based on, for example, a membership type, a security attribute, and/or advertising goals of the search service. For example, the index engine component 216 can be configured for determining whether the selected member is associated with a second search term using an index by locating, based on the selected member, a tag corresponding to the second search term in the tag index 220 according to the policy. The policy can be explicitly configured and/or can be implicit in the instructions of the search refiner component 226. The associated policy can provide for selection of a member of a second result set based on at least one of a profile associated with the submitter and a ranking among members of the result set.

Returning to FIG. 1, in block 110 a second result set is provided based on the second search term when the selected member is determined to be associated with the second search term. Accordingly, a system for providing search results based on selections in previously performed searches includes means for providing a second result set based on the second search term when the selected member is determined to be associated with the second search term. For example, as illustrated in FIG. 2, the search refiner component 226 is configured for providing a second result set based on the second search term when the selected member is determined to be associated with the second search term.

For example, as illustrated in FIG. 5, the tags are correlated to the result set of the first search term by the search refiner component 226 as depicted by message 518 and a second search term is generated based on the correlation. In example, referring to Table 1, a selection of a URI of a picture of Mount Rushmore is received by the search refiner component. Based on Table 1 and a policy indicating the highest weighted tag is to be selected as a second search term, the tag “President” is used in the generation of a second search term. The second search term is provided, as depicted in, for example, the message 520, by the search refiner component 226 to the search engine component 212 for processing a second search based on the second search term. The second search term is processed by the search engine component 212 in conjunction with the index engine component 216 to provide a second result set based on the second search term as depicted by the message 522. The result set is provided to a client such as the browser 206, as depicted by the messages 524 that in an aspect is an HTTP response message corresponding to the message 508 sent by the browser 206 as an HTTP request. Alternately, the second result set can be provided in a notify message 520 of a publish/subscribe protocol. This is appropriate when, for example, the member selected from the first result set is received in a message 508 that is a subscribe message or a publish message. When message 508 is formatted and sent as a publish message, the tag index is updated. As a result of the update, a notify message 520 can be sent to the subscriber associated with the message 502 when sent as a subscribe message. Other subscribers, in an aspect, can receive notifications based on the updated tag index (i.e., the selected member of the result set) when there is a relationship between other subscriber searches and the updated portion of the tag index.

In one aspect, the second result set is provided based on second search terms by generating the second result set based only on the second search terms. For example, the search refiner component 226 can be configured for providing a second result set based on one or more second search terms by generating the second result set based only on the second search term(s).

In another aspect, the second result set is provided based on the second search term by generating the second result set based on the first and second search terms. For example, the search refiner component 226 can be configured for providing a second result set based on the second search term by generating the second result set based on the first and second search terms. That is, the second search is generated using terms from the first search in addition to the tag or tags used as terms in the second search. The tag or tags used as terms in the second search can be related to terms in the first search query as determined using, for example, the tag-tag index 220 illustrated in FIG. 4. Alternatively, the second search query can be generated using a located tag and using the first search term to narrow scope, broaden scope, or otherwise change the search.

The second search result can be returned to the submitter of the first search term, such as a user of browser 206 and/or can be provided to another receiver. In addition, the second search term can be submitted to one or more other search services in addition to search service 202. The second result set can be provided for presentation with the first result set in an aspect. In another aspect, the second result set can be provided for presentation along with a presentation of a resource identified by the selected member.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any means that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), (g), or (n) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for providing search results based on selections in previously performed searches, the method comprising:
performing a search based on a first search term;
providing a result set from the performed search;
receiving a selection of a member of the result set from the performed search;
determining whether the selected member is associated with a second search term using an index that associates members from previously performed searches with corresponding search terms; and
providing a second result set based on the second search term when the selected member is determined to be associated with the second search term.

2. The method of claim 1 wherein receiving a selection of a member of the result set from the performed search includes processing a message received from a client to determine the selected member, the message identifying the selected member.

3. The method of claim 1 wherein receiving a selection of a member of the result set from the performed search includes selecting the member according to a policy that is associated with at least one of a submitter of the first search term, the client, an administrator associated with the submitter, and by a search service.

4. The method of claim 3 wherein the associated policy provides for selection of a member of the result set based on at least one of a profile associated with the submitter and a ranking among members of the result set.

5. The method of claim 1 wherein receiving a selection of a member of the result set from the performed search includes receiving the selection of the member without activating a link for retrieving a resource associated with the member.

6. The method of claim 1 wherein receiving a selection of a member of the result set from the performed search includes one of receiving one of a subscribe message for one of establishing and updating a subscription via a publish/subscribe service and a publish message for publishing the selection via a publish/subscribe service.

7. The method of claim 1 wherein determining whether the selected member is associated with a second search term using an index includes locating, based on the selected member, a tag corresponding to the second search term in a tag index that associates a tag with a resource.

8. The method of claim 7 wherein the tag index weights the associations according to at least one of the number of times a tag occurs in an associated resource, the number of links that reference an associated resource, where portions of an associated reference corresponding to a tag are in the associated reference.

9. The method of claim 1 wherein determining whether the selected member is associated with a second search term using an index includes locating, based on the selected member, a tag corresponding to the second search term in a tag index according to a policy that is associated with at least one of a submitter of the first search term, the client, an administrator associated with the submitter, and by a search service.

10. The method of claim 9 wherein the associated policy provides for selection of a member of a second result set based on at least one of a profile associated with the submitter and a ranking among members of the result set.

11. The method of claim 1 wherein providing a second result set based on the second search term includes generating the second result set based only on the second search term.

12. The method of claim 1 wherein providing a second result set based on the second search term includes generating the second result set based on the first and second search terms.

13. The method of claim 1 wherein providing a second result set based on the second search term includes providing a notify message pursuant to a subscription via a publish/subscribe service.

14. The method of claim 1, further comprising:
performing a lookup for an association including the first search term and the selected member of the second result set;
adjusting a correlation included in the association if the association is found;
creating an association including the first search term, the selected member, and a correlation if the association is not found.

15. The method of claim 1 wherein the second result set is provided for presentation with the first result set.

16. The method of claim 1 wherein the second result set is provided for presentation along with a presentation of a resource identified by the selected member.

17. A system for providing search results based on selections in previously performed searches, the system comprising:
means for performing a search based on a first search term;
means for providing a result set from the performed search; means for receiving a selection of a member of the result set from the performed search;
means for determining whether the selected member is associated with a second search term using an index that associates members from previously performed searches with corresponding search terms; and
means for providing a second result set based on the second search term when the selected member is determined to be associated with the second search term.

18. A system for providing search results based on selections in previously performed searches, the system comprising:
a search engine component configured for performing a search based on a first search term and for providing a result set from the performed search;
a selection receiver component configured for receiving a selection of a member of the result set from the performed search;
a tag index engine component configured for determining whether the selected member is associated with a second search term using an index that associates members from previously performed searches with corresponding search terms; and
a search refiner component configured for providing a second result set based on the second search term when the selected member is determined to be associated with the second search term.

19. The system of claim 18 wherein the selection receiver component is configured for receiving a selection of a member of the result set from the performed search by processing a message received from a client to determine the selected member, the message identifying the selected member.

20. The system of claim 18 wherein the selection receiver component is configured for receiving a selection of a member of the result set from the performed search by selecting the member according to a policy that is associated with at least one of a submitter of the first search term, the client, an administrator associated with the submitter, and by a search service.

21. The system of claim 20 wherein the associated policy provides for selection of a member of the result set based on at least one of a profile associated with the submitter and a ranking among members of the result set.

22. The system of claim 18 wherein the selection receiver component is configured for receiving a selection of a member of the result set from the performed search by receiving the selection of the member without activating a link for retrieving a resource associated with the member.

23. The system of claim 18 wherein the selection receiver component is configured for receiving a selection of a member of the result set from the performed search by one of receiving one of a subscribe message for one of establishing and updating a subscription via a publish/subscribe service and a publish message for publishing the selection via a publish/subscribe service.

24. The system of claim 18 wherein the tag index engine component is configured for determining whether the selected member is associated with a second search term using an index by locating, based on the selected member, a tag corresponding to the second search term in a tag index that associates a tag with a resource.

25. The system of claim 24 wherein the tag index weights the associations according to at least one of the number of times a tag occurs in an associated resource, the number of links that reference an associated resource, where portions of an associated reference corresponding to a tag are in the associated reference.

26. The system of claim 18 wherein the tag index engine component is configured for determining whether the selected member is associated with a second search term using an index by locating, based on the selected member, a tag corresponding to the second search term in a tag index according to a policy that is associated with at least one of a submitter of the first search term, the client, an administrator associated with the submitter, and by a search service.

27. The system of claim 26 wherein the associated policy provides for selection of a member of a second result set based on at least one of a profile associated with the submitter and a ranking among members of the result set.

28. The system of claim 18 wherein the search refiner component is configured for providing a second result set based on the second search term by generating the second result set based only on the second search term.

29. The system of claim 18 wherein the search refiner component is configured for providing a second result set based on the second search term by generating the second result set based on the first and second search terms.

30. The system of claim 18 wherein the search refiner component is configured for providing a second result set based on the second search term by providing a notify message pursuant to a subscription via a publish/subscribe service.

31. The system of claim 18, wherein the search refiner component is configured for:
performing a lookup for an association including the first search term and the selected member of the second result set;
adjusting a correlation included in the association if the association is found;
creating an association including the first search term, the selected member, and a correlation if the association is not found.

32. The system of claim 18 wherein the search refiner component is configured for providing a second result set based on the second search term by providing the second result set for presentation with the first result set.

33. The system of claim 18 wherein the search refiner component is configured for providing a second result set based on the second search term by providing the second result set for presentation along with a presentation of a resource identified by the selected member.

34. A computer readable medium including a computer program, executable by a machine, for providing search results based on selections in previously performed searches, the computer program comprising executable instructions for:
performing a search based on a first search term;
providing a result set from the performed search;
receiving a selection of a member of the result set from the performed search;
determining whether the selected member is associated with a second search term using an index that associates members from previously performed searches with corresponding search terms; and
providing a second result set based on the second search term when the selected member is determined to be associated with the second search term.
